(19) United States
(12) Patent Application Publication
(10) Pub. No.: US 2015/0248657 A1
(43) Pub. Date: Sep. 3, 2015

(54) SYSTEM AND METHOD FOR RECOVERING REFUNDABLE TAXES

(71) Applicant: MasterCard International Incorporated, Purchase, NY (US)

(72) Inventors: Ryan Christopher LOOCK, Congers, NY (US); John Frank AGLIALORO, Sparkill, NY (US); Victor Claes David NORDENSON, Stamford, CT (US)

(21) Appl. No.: 14/448,284

(22) Filed: Jul. 31, 2014

(30) Foreign Application Priority Data
Feb. 28, 2014 (GB) 1403614.9

(51) Int. Cl. G06Q 20/20; G06Q 20/26; G06Q 20/10; G06Q 50/26; G06Q 20/40

(52) U.S. Cl. CPC G06Q 20/207; G06Q 50/26; G06Q 20/4014; G06Q 20/10; G06Q 20/26

(57) ABSTRACT

A method for processing a payment transaction relating to a purchase and refunding a tax paid on the purchase, the method comprising (i) receiving, over a network from a merchant apparatus, payment transaction data relating to a payment transaction associated with an electronic payment card, (ii) analysing the payment transaction data to determine whether the payment transaction is eligible for a tax refund; (iii) determining a tax refund value relating to the payment transaction; and (iv) coordinating between an issuer associated with the electronic payment card and a tax authority in order to credit an account associated with the electronic payment card with the tax refund value. The invention thereby provides a scheme or process by which an overseas cardholder can be provided with a refund of the tax paid on eligible purchases in a manner that is user-friendly, that has traditionally been performed in a largely paper-based environment.

### TECHNICAL FIELD

The invention relates in general to electronic transactions carried out within the context of a financial authorisation, clearing and settlement system. More specifically, the invention relates to a process for handling the recovery of refundable taxes that have been levied during such electronic transactions for the payment of goods and services.

### BACKGROUND

A feature that is common to the retail industry world-wide is the imposition of a sales tax or value added tax (known as VAT) to the purchases of various goods and services. Such taxes are applied for a variety of reasons such as to discourage or promote spending on certain goods categories, and serve as a significant revenue generator for a respective government. The UK, for example, imposes a ‘value added tax’ (VAT) of 20% on many categories of goods and services that are purchased. Typically such taxes will be variable in order to achieve certain economic objectives.

In some countries these taxes may be refundable to non-resident visitors under certain conditions. Staying with the UK by way of example, the ‘VAT Retail Export Scheme’ permits non-EU residents visiting the UK to recover VAT on goods they buy for personal export outside the EU. The Retail Export Scheme thus contributes to the UK economy by encouraging overseas visitors to buy goods when they visit the UK since the effective cost of those goods is reduced. The EU-wide scheme ensures that goods are taxed only where they are used and prevents ‘double taxation’, which could otherwise occur if goods were taxed in the EU when they are purchased and again in the visitor's home country when imported.

Currently, the process of obtaining a VAT refund on purchases is largely paper-based. In a typical process, when an overseas visitor visits a shop or ‘merchant’ in the UK and wishes to obtain a refund of the VAT levied on the transaction, the retailer and the customer complete a tax recovery document (e.g. HMRC official form VAT407) with details of the transaction. A prerequisite of this, however, is that the retailer participates on the VAT Retail Export Scheme, usually identified by the Tax Free Shopping′ sign.

When leaving the EU, the visitor is required to present the tax recovery document and the goods at UK customs at their point of departure from the EU for inspection and validation by a customs official. Once the tax recovery document has been approved by customs, the tax recovery document may be sent to the retailer who will then refund the visitor and ‘zero-rate’ the transaction in the business accounts. Some retailers pay the refund directly, but others may choose to operate through a third party refund company. Alternatively some retailers may have arrangements with a refund booth at UK departure ports, and perhaps other locations such as shopping malls, which provide visitors with the facility to obtain refunds before leaving the country. Note that other EU countries have similar Retail Export Schemes in place and similar processes exist for many non-EU countries.

As will be appreciated by the above discussion, the process is by-and-large a manual one and requires engagement between retailers and customers to fill in documentation which reduces the effectiveness of the process, reduces take-up and, ultimately, may discourage overseas visitors from spending on big-ticket items in the home country. Thus, there is a need to increase the efficiency of the process.

One proposal is described in U.S. Pat. No. 6,546,373 (B1) in which purchases subject to VAT (or sales tax) made by a traveller are recorded on an electronic transaction card that is loaded with a dedicated software application that is able to record the relevant purchases. During the traveller's visit to a foreign country, the electronic transaction card records the purchases made and accumulates the refundable tax amount. When the traveller leaves the country, the electronic transaction card may be inserted into a suitable terminal which reads the purchase information and manages a tax refund application process including communicating with a suitable taxing authority and tax recover application supplier if appropriate. The traveller may be issued with a tax refund for eligible purchases there and then at the terminal.

It is against this background that the invention has been devised

### STATEMENTS OF INVENTION

In one aspect, the invention provides a method for processing a payment transaction relating to a purchase and refunding a tax paid on the purchase. The method comprises
receiving, over a network from a merchant apparatus, payment transaction data relating to a payment transaction associated with an electronic payment card,
analysing the payment transaction data to determine whether the payment transaction is eligible for a tax refund,
determining a tax refund value relating to the payment transaction, and
coordinating between an issuer associated with the electronic payment card and a tax authority in order to credit an account associated with the electronic payment card with the tax refund value.

The invention may also be expressed as, and therefore also embraces, a system for processing a payment transaction relating to a purchase and refunding a tax paid on the purchase, the system comprising:
a merchant apparatus configured to generate a payment transaction relating to a purchase and to transmit the payment transaction over a network;
a transaction processor configured to receive the payment transaction generated by the merchant apparatus to transmitted to it over the network, wherein the transaction processor is configured to:
analyse the payment transaction data to determine whether the payment transaction is eligible for a tax refund;
determine a tax refund value relating to the payment transaction; and
coordinate between an issuer associated with the electronic payment card and a tax authority in order to credit an account associated with the electronic payment card with the tax refund value.

Advantageously, the invention provides a scheme or process for harvesting data from payment transactions and providing the cardholder relating to the transaction with the facility to obtain a refund of the tax that is paid on the purchase. Known systems for claiming tax refunds are largely paper-based and require a significant level of involvement from both the merchant and from the user/cardholder at the point of sale. This administrative burden reduces the financial incentive for the cardholder to make a tax reclaim which means take up is generally poor in comparison with the level of overseas travel. The invention, however, provides a process which is largely transparent to the user by integrating an automated process within the existing organisational infrastructure and networks of the transaction processor that manages the payment transactions between merchants, acquirers and issuers.

In order to identify transactions that should be eligible for a tax refund, a stakeholder database may be built so that data relating to a cardholder corresponding to the electronic payment card may be stored for identify verification. The stakeholder database may therefore act as a filter to identify payment transactions that are eligible to take part in the VAT refund process by cross referencing cardholder data relating to the transaction with cardholder data stored in the database. In this way, it can be determined that the payment transaction is ‘cross-border’ and so is, in principle, eligible for a tax refund. Alternatively, the transaction can be verified as a cross-border transaction by the setting of a flag in the payment transaction data.

In one embodiment, the step of receiving data relating to a payment transaction may be achieved by monitoring the authorisation process between a merchant apparatus and an issuer associated with the electronic payment card. Therefore, the data is effectively ‘picked out’ of authorisation messages passing between the merchant apparatus and the issuer associated with the cardholder, via the acquirer. Thus, the process is able to be integrated seamlessly into existing payment transaction protocols. One alternative is for data relating to the payment transaction to the provided after the payment transaction to be concluded. For example the merchant apparatus may communicate directly with the transaction processor to upload relevant transactions thereto.

The analysis of the payment transaction data may include identifying the type of goods to which the payment transaction relates. This allows the transaction processor to determine if the goods that have been purchased are a type of goods that the relevant tax authority has indicated is tax-reclaimable, and may involve the identification of a category code in the payment transaction data and verification that the category code corresponds to goods eligible for a tax refund.

In order to determine the tax refund value, the transaction processor may be configured to read data from a tax data field in the payment transaction data that has been populated by the merchant apparatus. This relies on the merchant apparatus calculating the tax value at their point of sale apparatus which can be beneficial in some circumstances since the merchant is able to determine reliably at the outset that a tax refund may be called for. Alternatively, however, the transaction processor may be configured to calculate a tax amount based on a transaction amount field included in the payment transaction data. In doing so, the transaction processor may be configured to verify a tax rate applicable to the payment transaction, the tax rate being transmitted with the payment transaction data or, alternatively, obtained from internal storage means.

The transaction processor may be configured to communicate with the tax authority to obtain funding corresponding to the tax refund value. This may occur before or after the transaction process communicates the payment transaction to the issuer in order for the issuer to credit an account associated with the cardholder with an amount corresponding to the tax refund value.

Within the scope of this application it is intended that the various aspects, embodiments, examples and alternatively set out in the preceding paragraphs, in the claims and/or, in the following description and drawings, and in particular the individual features thereof, may be taken independently or in any combination. Features described in connection with one embodiment are applicable to all embodiments unless expressly stated or unless such features are incompatible.

### BRIEF DESCRIPTION OF THE DRAWINGS

In order that the invention may be more readily understood, reference will now be made, by way of example, to the accompanying drawings in which:

FIG. 1 is a system diagram illustrating the entities involved in a system and process according to an embodiment of the invention;

FIG. 2 is a flowchart illustrating a process of an embodiment of the invention; and

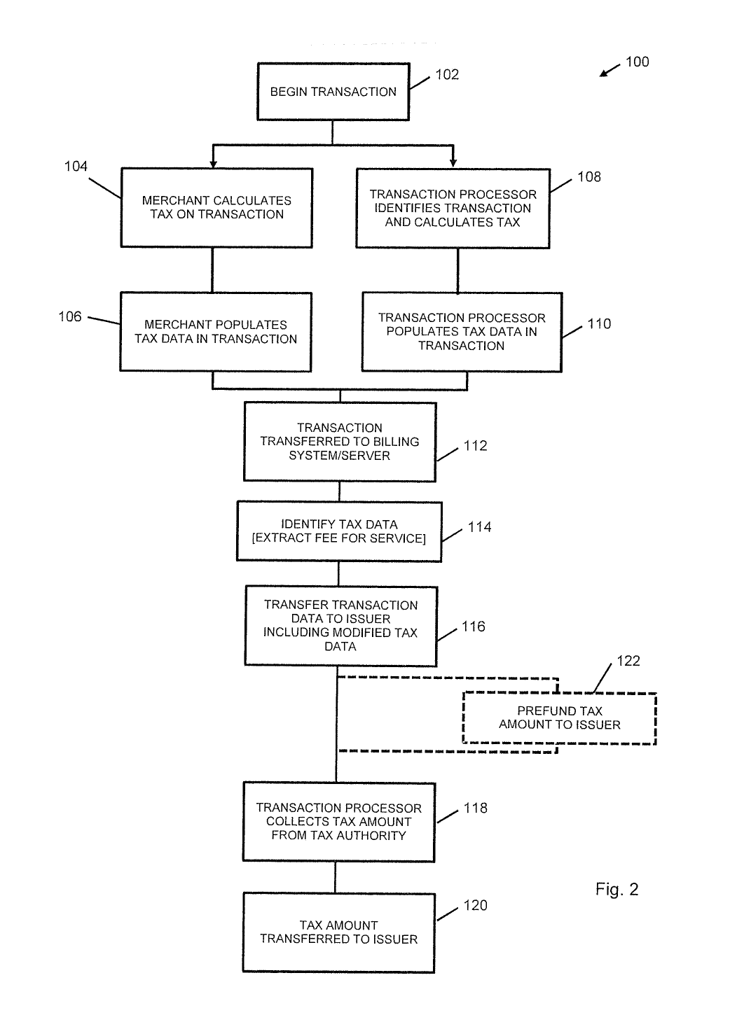

FIG. 3 is an example of data content of a payment transaction message;

### DETAILED DESCRIPTION OF THE INVENTION

The process will be described in the context of VAT regime currently operating in the UK, although the skilled person will appreciated that the invention is also applicable to other ‘sales tax’ regimes in other countries. Hereinafter, references to terms such as ‘VAT’, ‘tax’ and the like shall be taken to be a sales tax imposed on goods and services unless otherwise stated.

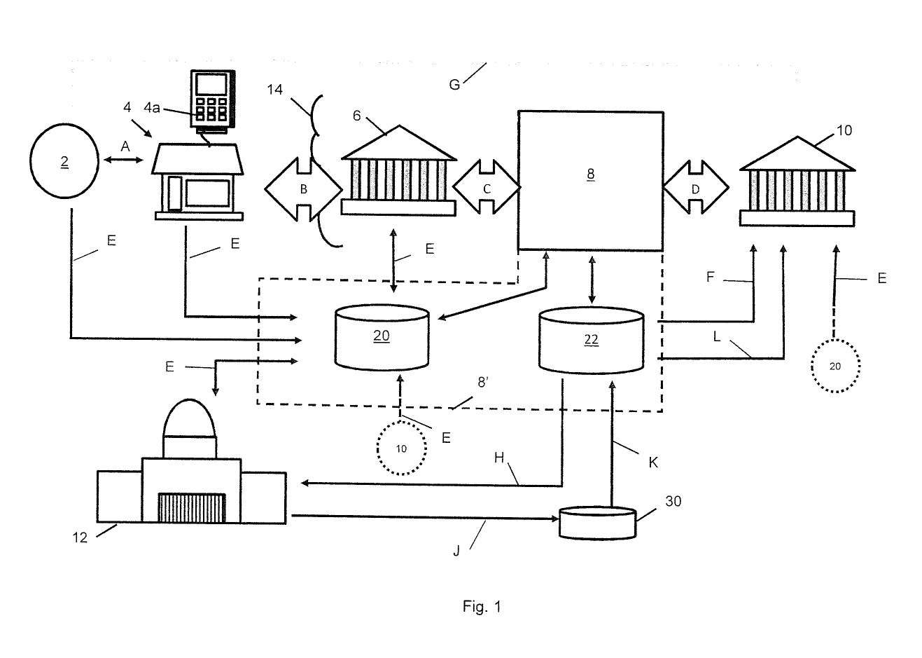

FIG. 1 illustrates a block diagram of a system supporting a financial transaction between a cardholder 2 and a merchant 4, which also involves a merchant acquirer bank, or more simply ‘acquirer’ 6, a transaction processor 8 and an issuing bank, or more simply ‘issuer’ 10. FIG. 1 also illustrates the participating entities in a process by which the cardholder 2 may be recompensed for the tax (in this case, VAT) paid on the amount of the transaction. In overview, these participating entities are the transaction processor 8 and a tax authority 12. In the UK context, the service of the transaction processor 8 may be provided by a payment network infrastructure brand such as Visa or MasterCard, although the skilled person will be aware of other such service organisations. Likewise, the tax authority 12 is HMRC (Her Majesty's Revenue and Customs).

At this point, it should be appreciated that the terms ‘issuer’, ‘acquirer’, ‘merchant’ and ‘tax authority’, and the like are intended to mean computer implemented systems that represent those establishments and that are able to communicate data and instructions between one other, as appropriate, using established protocols.

The financial transaction is a payment transaction for the purchase of goods/services in which the merchant 4 communicates with a financial transaction network 14 for authorisation for the payment prior to later completion of the transaction by way of a clearance and settlement process, as would be known to the skilled person. Since the tax refund process relates to the claiming back of goods purchased in the UK, it is envisaged that the financial transaction will relate to transactions originating in physical ‘bricks and mortar’ establishments to minimise fraud opportunities as opposed to online ‘cardholder not present’ payments which may be originated at locations outside of the UK. It should be noted, however, that ‘cardholder not present’ type payment transactions that may be conducted using a digital wallet may also be used. Here, the cardholder is an overseas resident

Although the authorisation, clearing and settlement stages of a complete payment transaction would be familiar to the person skilled in the art, a brief overview will be provided here for completeness.

Authorisation

On initiation of a transaction, the merchant constructs an authorisation request including payment information and sends the authorisation request to its financial institution, the acquirer, for authentication. The acquirer authenticates the identity of the customer/cardholder and forwards the authorisation request to the transaction processor (for example MasterCard or Visa, depending on the payment card branding) for account validation and routing. At this point, the transaction processor may also perform additional security checks such as risk profiling and fraudulent activity detection. From there, the transaction processor routes the authorisation request to the issuer, for verification. Once the issuer verifies the availability of funds for the amount of the transaction, and ring fences them, it sends the verification back to the transaction processor. In turn, the transaction processor routes the verification to the acquirer who, in turn, notifies the merchant that the purchase has been approved.

Clearing

Following completion of the transaction between the cardholder and the merchant, the transaction undergoes ‘clearing’. Typically within a day of authorisation, the merchant batch-transmits all of their sales transactions associated with the organisation represented by the transaction processor to the acquirer. The acquirer batches and sends the payment information to the transaction processor which then validates the accuracy of the transaction information submitted by the acquirer in order to reconcile funds between issuers and acquirers. This reconciliation process balances funds between payment parties on a regular basis.

Settlement

Typically within two days of authorisation, and after transactions have been cleared, the transaction processor calculates the debited and credited amounts between issuers and acquirers, also termed the ‘net settlement position’. During this process, the issuer is informed of the funds to be debited from cardholder accounts to settle transactions and the acquirer is informed of the funds to be credited to merchant accounts net of fees levied by the transaction processor.

Cardholder/Merchant Enrollment Process

Prior to the commencement of a financial transaction from which the tax may be refunded, cardholder 2 is required to enroll or register with a knowledge network which is illustrated as database 20. Here, the ‘knowledge base’ 20 is shown as part of the established business infrastructure of the transaction processor 8 and is illustrated by the dashed boundary line 8′. The knowledge base 20 provides access to ‘know your customer data’ for relevant entities or ‘stakeholders’ involved in the tax refund process and thereby allows the transaction processor 8 to arrange for collection of tax refunds on behalf of the cardholders. In this example the relevant stakeholders are the merchant 4, the acquirer 6, the transaction processor 8, the issuer 10 and the tax authority 12. Although the knowledge base 20 is shown here as being part of the organisational infrastructure of the transaction processor 8, alternatively it is envisaged that the database 20 may be a cloud-hosted system that may be provided by a different, but trusted, organisation.

In the enrollment/registration process of the cardholder 2, the cardholder provides a variety of data items. For instance, the cardholder may provide such data items as: name, address, country of residence, citizenship, contact details, and details of the card which they wish to be registered on the scheme. Other data items would be apparent to the skilled person. All such data items are combined into a suitable cardholder entry in the database 20 that is accessible by the transaction processor 8. The enrollment process is in essence an administrative exercise and, as such, may be a paper-based process in which the cardholder 2 completes a suitable registration form and sends this to the transaction processor 8 by mail for processing. Alternatively, and more efficiently, the enrollment process may be carried out in online environment, for example as could be provided by a suitable software application or ‘app’ implemented on a mobile computing device such as a tablet computer of smartphone. The data provided during the enrollment process may be augmented at a later date as required; for instance the cardholder may supply travel details such as inbound and outbound flight information which will provide a means of verifying the travel status of the cardholder.

Similarly, in the enrollment/registration process of the merchant 4, the merchant 4 also provides a variety of data items that are required by the knowledge base 20 and which are established in a suitable merchant entry in the knowledge base 20. The merchant may provide such data items as identification data, merchant ID (MID), one or more merchant category codes (MCCs) which identify the types of goods that the merchant sells, which may be both eligible and ineligible for tax refund.

The enrollment process therefore harvests data from the cardholder 2 in particular, but also the merchant 4, so that these parties may be pre-vetted and thereby authorised to participate in the tax refund process. Thus, the tax authority 12 can impose certain data requirements that must be satisfied for cardholders and merchants to participate in the process, and the transaction processor 8 is therefore able to implement risk management processes to evaluate cardholders and merchants and ensure that they have a suitable low risk profile. Here, the data flows for each of the parties relating to the enrollment process are indicated by the common reference ‘E’.

Transaction Process

Returning to the transaction process, it begins by the initiation of a financial transaction by the cardholder 2 communicating with the merchant 4 as indicated by arrow ‘A’ in order to pay for goods and services and, more specifically, to seek authorisation for the payment. This may be by way of the cardholder 2 processing their electronic payment card through a point of sale (POS) apparatus 4a associated with the merchant via a chip and pin card reader or by interaction with a digital wallet carried on a suitable mobile payment device such as a mobile phone, for example, in which the mobile payment device acts as a proxy for a physical card. Accordingly, the transaction may be conducted under the EMV (Europay Mastercard Visa), ISO/IEC 7816, and ISO/IEC 14443 standards, as are known in the art, although other transaction protocols also apply.

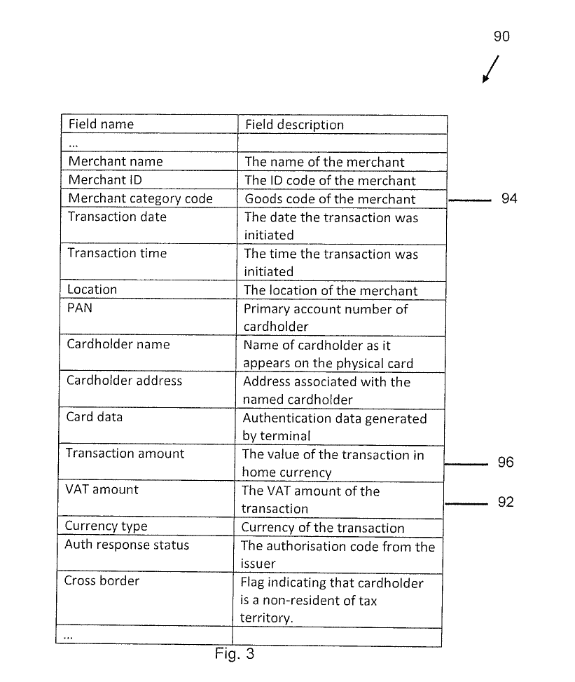

The merchant 4 then completes the necessary authentication checks and constructs or ‘builds’ a payment transaction data structure in the form of an ‘authorisation request’ and communicates with the acquirer 6 via the network 14, which may be the internet or another suitable telecommunications network, in order to obtain an authorization for the payment that the cardholder 2 wishes to make, as indicated by arrow ‘B’. In response, the acquirer 4 then communicates the authorisation request to the transaction processor 8, as illustrated by arrow ‘C’. An exemplary financial transaction data structure 90 is shown in FIG. 3 and includes suitable data fields relevant to the transaction, for example the name and address of the cardholder, card data, the primary account number (PAN) of the card, transaction date and time data, merchant information including the name, ID code and merchant category code (MCC) or multiple MCCs if applicable, transaction value data, currency type, VAT value data, and authorisation status data.

At this point the transaction processor 8 communicates (arrow D) with the issuer 10 of the cardholder's card after it has carried out appropriate validation and security checks. The issuer 10 then carries out necessary credit worthiness checks to ensure that the account balance of the cardholder is sufficient to cover the payment amount and fraudulent activity checks and communicates a response back to the transaction processor 8 (arrow ‘D’) either granting authorization for the transaction or denying authorization. It should be noted that since the process relates to the manner in which a VAT-refundable goods/services are purchased by the cardholder 2 who is resident overseas, it will be appreciated that the issuer 10 may not be resident in the same country as the merchant. More likely, in fact, that the issuer 10 is based in the same country as the cardholder 2 has residency, although this is not essential.

The transaction will also include the authorization/denial from the issuer 10 and the transaction processor 8 communicates back to the acquirer 6 (arrow ‘C’). Having received the transaction including authorization/denial from the issuer 10 the acquirer 6 then communicates the transaction back to the merchant 4 (arrow ‘B’). At this point, the merchant 4 has received the authorization for the original transaction and so the merchant 4 communicates the authorization to the user/cardholder 2, as illustrated by arrow ‘A’, thereby completing the transaction.

As discussed above, an overseas user/cardholder 2, particularly a non-EU resident, may purchase goods for which they wish to claim back the VAT paid on the goods, which is currently 20% in the UK. The process of the invention provides a means for the user to make such a tax reclaim by way of an electronic system which avoids the need to complete a paper-based tax refund application on the premises of the merchant 4 and provides a much more flexible and swift resolution to the application.

Tax Refund Scheme/Process

The process 100 by which the cardholder 2 is able to obtain a refund of the VAT paid on the transaction operates in conjunction with the payment transaction described above with reference to FIG. 1.

Step 102 illustrates the beginning of the payment transaction in FIG. 1, as started by an ‘overseas’ cardholder 2 agreeing to a purchase goods or services (hereafter simply ‘goods’) that are eligible for a tax refund and starting a payment traction with their card by way of the merchant's POS apparatus 4a. Here, it is assumed that the cardholder 2 has enrolled into the knowledge base 20 so that the transaction processor 8 is ‘alert’ to transactions initiated by the cardholder 2 away from their country of residence. It is also assumed that the goods that the cardholder is purchasing are eligible for VAT refund.

At this point the merchant 4 may carry out appropriate checks to determine that the cardholder is, in principle, eligible to reclaim VAT that will be paid on the purchase. For this, the merchant may check the cardholder's passport and travel details such as airline tickets to validate that the cardholder is indeed an overseas traveller thereby providing an element of fraud prevention. Assuming that the cardholder is eligible to reclaim VAT on the purchase, the process follows one of two alternative routes. The first alternative is illustrated on the left hand branch of the diagram and it should be noted that the following steps take place during the authorisation stage of the financial transaction. At step 104, the merchant 4 identifies the purchased goods as being eligible for a tax refund. This may be through the entry of a suitable merchant category code (MCC) into the payment transaction data structure 90, as would be understood by the skilled person. Alternatively, or in addition, the merchant 4 may add a further level of product detail in the form of “SKU level” data (SKU: ‘stock keeping unit’) which would list the specific product being purchased and therefore identify it as being an eligible product type for a VAT refund or otherwise. Following this, the merchant 4 calculates the tax value of the purchase and generates a tax value that is incorporated into a data field provided in the payment transaction data structure 90 at step 106. The tax data field is indicated at reference 92 in FIG. 3.

Following the population of the transaction data structure 90 with the tax data field 92, the payment transaction continues through the established authorisation process as described above.

The second alternative is illustrated on the right hand branch of the flow chart and it should be noted that the following two steps take place after the authorisation stage of the financial transaction.

In this alternative route, the merchant 4 is not required to perform any calculations with regard to the tax amount of the payment transaction. Instead, the responsibility for calculating the tax amount passes to the transaction processor 8.

Thus, at step 108 the transaction processor 8 identifies the payment transaction as one which requires modification for tax refund purposes. The transaction processor 8 may identify the payment transaction during the authorisation process between the merchant 4 and the issuer 10 or, as is currently preferred, the transaction processor 8 may identify the payment transaction after the authorisation process has completed, during the clearing stage of the financial transaction. For this, the transaction processor 8 may leverage the information stored in the knowledge base 20 to cross reference the cardholder identified in the transaction with the cardholders enrolled in the VAT refund scheme in the knowledge base 20. This process therefore acts in the manner of a filter to identify those transactions that need to be processed suitably to generate a VAT refund event.

When the payment transaction has been identified as one which requires modification, the transaction processor 8 operates firstly to identify the category of goods to which the payments transaction relates and, secondly, determines the relevant tax amount.

The process of identifying, from the payment transaction data structure 90, whether the goods are tax refund eligible in this embodiment involves the transaction processor 8 reading a merchant category code (MCC) field, as illustrated at 94. As mentioned, this information indicates the type of goods that the merchant sells or, alternatively, a plurality of MCCs may apply to a single merchant (for example if the merchant is a department store) in which case the MCC may indicate the type of goods sold in a particular department, concession or other store sub-division.

Once the type of goods have been identified, and therefore recognised as being eligible for a tax refund, the transaction processor 8 performs further checks against relevant criteria to determine whether a tax refund is needed. Here it is envisaged that the transaction processor 8 will, amongst other things, check the country of residence of the cardholder 2 in the knowledge base 20 to determine whether the transaction is indeed a ‘cross border’ transaction, and therefore eligible for a tax refund.

If it is determined that a tax refund is not permitted, then the process will terminate. However, if it is determined that a tax refund is required, the process continues to step 110 at which point the transaction processor 8 calculates the tax amount of the payment transaction and populates the payment transaction data structure 90 with the tax data field 92. Here, the transaction processor 8 may query an appropriate internal memory store, which may be provided by the knowledge base 20, that is configured to hold tax rates applicable to each category of goods and apply the appropriate tax rate to the transaction amount field 96 in the payment transaction.

Once the financial transaction data structure 90 has been populated with the tax data entry as described above, at step 112 the transaction is transferred to a billing subsystem of the transaction process, as illustrated in FIG. 1 by reference 22. In practice the transaction would be one of many thousands of transactions that are transferred to the billing system 22 in order to facilitate the tax refund operation.

In this embodiment, in addition to carrying out established settlement stage processes, the billing subsystem 22 is operable to identify those transactions that require processing due to a tax refund and to carry out suitable processing to i) communicate with the issuer in order to cause the cardholder to be credited with a tax refund amount and ii) collect suitable funds from the tax authority to fund the tax refund amount.

Accordingly, at step 114 the billing subsystem 22 identifies those transactions that require VAT processing by analysing the tax data field 92 of the data structure 90 of each transaction that is transferred to it.

In order to fund the tax refund service that the transaction processor 8 provides to cardholders, the billing subsystem 22 modifies the tax data field 92 by subtracting from this field an amount equal to a service fee. This may be configured to be any suitable amount, although it is envisaged that a suitable level for the service fee will be in the region of 5% to 10% of the total value of the tax amount.

Following modification of the tax data field 92, at step 116 the billing subsystem 22 transfers the financial transaction to the issuer 10, as is also illustrated by arrow ‘F’ in FIG. 1. As an alternative at this point, the billing subsystem 22 may transfer only the tax data field 92 to the issuer 10.

In response to receiving the modified transaction from the billing subsystem 22, including the tax data field 92, the issuer 10 is then able to credit the account of the cardholder 2 for the amount of the tax data element 92, as illustrated by arrow ‘G’. Therefore, the cardholder receives a refund for the tax paid on the purchase, less the fee levied by the transaction processor 8 for providing the service and any further fees judged to be suitable by the issuer 10. It is envisaged that the credit to the cardholder's account will be completed within two billing cycles, although this is not essential. Suitable notifications can be provided in correspondence sent to the cardholder to make them aware of the service and the timescales within which their account will be credited.

Following transmission of the financial transaction to the issuer 10, at step 118 the billing subsystem 22 operates to collect the full amount of the refundable tax on the purchase from the tax authority 12. It should be appreciated that various methods exist for collecting the refundable tax from the tax authority 12.

In this embodiment, however, an account 30 is established on behalf of the tax authority 12 through a suitable payment gateway provider such as DataCash®. This account 30 may be funded by the tax authority 12 at a predetermined frequency, for example on a monthly basis. In order to trigger funding of the account 30 by the tax authority 12, the billing subsystem 22 may submit a payment request (arrow ‘H’) to the tax authority 12 through established electronic invoicing infrastructures which comprise sufficient detail regarding the tax refund eligible purchase transaction to serve as an auditing function. The tax authority 12 would then fund the account 30 as necessary, as illustrated by arrow ‘J’.

Alternatively, the tax authority 12 may be configured to make payments to the account 30 on a predetermined schedule in advance of a fund request from the billing subsystem 22 but based on an expected VAT refund levels for a given time period.

Finally, the transaction processor 8, via the billing subsystem 22, is able to draw down funds from the account, as illustrated at arrow ‘K’, in order to make payment to the card issuer 10 as means to settle the payment made to the cardholder by the issuer 10, and also to provide its fees levied for the service. Once appropriate funding for the tax refund has been collected, the billing subsystem 22 at step 120 is able to pass the necessary funds to the issuer 10 to recompense the issuer 10 for crediting the cardholder in advance, as also illustrated at arrow ‘L’ in FIG. 1.

In the above embodiment, payment is made from the billing subsystem 22 to the issuer 10 as the final step 120 in the process. So, in this situation the issuer 10 credits the cardholder 2 before it has the requisite funds to issue the credit. Optionally, however, the billing subsystem 22 may pre-issue funds to the issuer 10 even though it has not yet collected the funds from the tax authority 12. This optional step, illustrated as step 122, occurs prior to the collection of funds form the tax authority 12 and in conjunction with the transaction data being transferred to the issuer 10, as occurs at step 116. So, in this alternative scenario, the issuer 10 would receive the transaction data including the modified tax data field 92 and would also be provided with funding for each tax refund in readiness for providing a credit to the cardholder account.

The electronic processing and management of tax refunds in this way offers many benefits. Importantly, the process enables the account of the cardholder 2 to be credited with funds equal to the tax paid on overseas purchases without any action by the cardholder 2 at the port of exit of the country, and in a manner that is much quicker than any known tax refund solutions. To achieve this, the established business infrastructure of the transaction processor 8 is used to provide a more efficient system to coordinate and fulfil tax refunds for cardholders that are a member of its network.

Compared to existing systems, where the cardholder 2 must complete hard-copies of the appropriate forms to record the purchases and then present these forms for inspection at customs, the invention provides a more transparent process for the cardholder which encourages take up amongst consumers when travelling. What is more, the cardholder receives the tax refund swiftly, typically within one or two billing cycles, which is faster than is currently the case.

Furthermore, since the tax refund scheme operates through an existing cooperative network of card-issuing banks, acquirers, merchants and payment processors, which are augmented through the knowledge network, there is increased assurance over the identity of the cardholder who is making the tax refund claim, and control over the use of the card. As such, where a card is used to purchase goods under the scheme and then is used subsequently to claim a refund of the purchase tax, there is established traceability of the individual using the card. This traceability acts as a significant deterrent to fraudulent claims from consumers and provides greater traceability and transparency than the paper-based schemes which, typically, only require passport details as the form of identification.

A significant advantage of the ‘automated’ tax refund scheme described herein is that the merchant is required to perform less administrative work compared with the current paper-based system since there is a reduction in paperwork that needs to be completed at the point of sale. Not only is this an operational burden for the merchant but it is usually considered difficult for the merchant to implement the process in a way that complies fully with the requirements of the tax authority. The ‘automated’ scheme as described above would remove the need for the merchant to create manual document and would simply require the merchant to register with the scheme.

Since the administrative burden on merchants is reduced, it is envisaged that the numbers of merchants willing to participate in the tax refund scheme will increase, as will the geographical distribution of the network of merchants that is likely to encourage retail shopping by international consumers. In turn, this is likely to lead to a wider range of goods that are eligible for vat refunds and may increase market competition for those goods that will benefit the consumer.

It is envisaged that the electronic tax refund process may operate in parallel with an established ‘paper-based’ equivalent scheme pending increased take up of the electronic scheme to a stage that there is justification for disbanding the paper-based counterpart.

The invention also confers benefits for the tax authority since it is no longer required to inspect the paperwork and purchased goods in respect of cardholder that are enrolled in the tax refund scheme of the transaction processor. This reduces the volume of transactions which the tax authority must process and, thus, reduces its operational costs.

1. A method for processing a payment transaction relating to a purchase and refunding a tax paid on the purchase, the method comprising:
receiving, over a network from a merchant apparatus, payment transaction data relating to a payment transaction associated with an electronic payment card,
analysing the payment transaction data to determine whether the payment transaction is eligible for a tax refund;
determining a tax refund value relating to the payment transaction; and
coordinating between an issuer associated with the electronic payment card and a tax authority in order to credit an account associated with the electronic payment card with the tax refund value.

2. The method of claim 1, further including building a stakeholder database of registered participants such that data relating to a cardholder corresponding to the electronic payment card is stored for identity verification.

3. The method of claim 1, wherein receiving payment transaction data comprises monitoring an authorisation process between the merchant apparatus and an issuer associated with the electronic payment card.

4. The method of claim 1, wherein receiving data relating to a payment transaction includes verifying that the payment transaction is a cross-border payment transaction.

5. The method of claim 4, wherein verifying that the payment transaction is a cross-border payment transaction includes checking a flag in the payment transaction data.

6. The method of claim 4, when dependent on claim 2, wherein verifying that the payment transaction is a cross-border payment transaction includes cross referencing a cardholder-data field against registered cardholder participants in the stakeholder database.

7. The method of claim 1, wherein analysing the payment transaction data comprises identifying the type of goods to which the payment transaction relates.

8. The method of claim 7, including identifying a category code in the payment transaction data and verifying that the category code corresponds to goods eligible for a tax refund.

9. The method of claim 1, wherein determining the tax refund value includes reading data from a tax data field in the payment transaction data that has been populated by the merchant apparatus.

10. The method of claim 1, wherein determining the tax refund value includes calculating a tax amount based on a transaction amount field included in the payment transaction data.

11. The method of claim 10, wherein determining the tax refund value further includes verifying a tax rate applicable to the payment transaction.

12. The method of any of claim 1, wherein coordinating between the issuer associated with the electronic payment card and the tax authority includes communicating the payment transaction to the issuer in order for the issuer to credit an account associated with the cardholder with an amount corresponding to the tax refund value.

13. The method of claim 12, further including communicating with the tax authority to obtain funding corresponding to the tax refund value.

14. A system for processing a payment transaction relating to a purchase and refunding a tax paid on the purchase, the system comprising:
a merchant apparatus configured to generate a payment transaction relating to a purchase and to transmit the payment transaction over a network;
a transaction processor configured to receive the payment transaction generated by the merchant apparatus to transmitted to it over the network, wherein the transaction processor is configured to:
analyse the payment transaction data to determine whether the payment transaction is eligible for a tax refund;
determine a tax refund value relating to the payment transaction; and
coordinate between an issuer associated with the electronic payment card and a tax authority in order to credit an account associated with the electronic payment card with the tax refund value.

15. The system of claim 14, wherein the transaction processor is configured to build a stakeholder database of registered participants such that data relating to a cardholder corresponding to the electronic payment card is stored therein for identify verification.

16. The system of claim 14, wherein the transaction processor is configured to monitor an authorisation process between the merchant apparatus and an issuer associated with the electronic payment card.

17. The system of claim 14, wherein the transaction processor is further configured to verify that the payment transaction is a cross-border payment transaction.

18. The system of claim 15, wherein the transaction processor is configured to cross reference a cardholder-data field in the payment transaction against registered cardholder participants in the stakeholder database.

19. The system of claim 14, wherein the transaction processor is configured to identify the type of goods to which the payment transaction relates.

20. The system of claim 19, wherein the transaction processor is configured to read data from a tax data field in the payment transaction data populated by the merchant apparatus.

21. The system of claim 19, where the transaction processor is configured to determine the tax refund value by calculating a tax amount based on a transaction amount field included in the payment transaction data.

22. The system of claim 21, wherein the transaction processor is further configured to verify a tax rate applicable to the payment transaction.

23. The system of claim 14, wherein the transaction processor is configured to communicate the payment transaction to the issuer in order for the issuer to credit an account associated with the cardholder with an amount corresponding to the tax refund value.

24. The system of claim 23, wherein the transaction processor is further configured to communicate with the tax authority to obtain funding corresponding to the tax refund value.
